(19) United States
(12) Patent Application Publication
(10) Pub. No.: US 2011/0298193 A1
(43) Pub. Date: Dec. 8, 2011

(54) SKATE CAR STRUCTURE

(75) Inventor: JEENG-NENG FAN, TAOYUAN (TW)

(73) Assignee: HSIN LUNG ACCESSORIES CO., LTD., HSIN CHU HSIEN (TW)

(21) Appl. No.: 12/838,648

(22) Filed: Jul. 19, 2010

(30) Foreign Application Priority Data
Jun. 4, 2010 (TW) 099210727

(51) Int. Cl. B62M 1/00

(52) U.S. Cl. 280/221

(57) ABSTRACT

An improved skate car structure includes a control member installed at a frame that is provided for fixing a front pipe, an elastic restoring element installed in the control member and coupled to the frame, a positioning ear disposed separately on both sides and provided for a pivoted bolt to pivotally installing left and right support rods; a pivoted bolt installed at the frame for positioning the left and right support rods, a handlebar and a front driving wheel installed at ends of the front pipe respectively, and a rear driving wheel module installed at a rear end of the left and right support rods, swung freely and restored automatically, such that after a user stands on the left and right support rods, the user can twist his body, hip or both legs to apply forces or swing the handlebar sideway to drive the car body to slide forward.

### BACKGROUND OF THE INVENTION

1. Field of the Invention

The present invention relates to an improved skate car structure, and more particularly to a skate car structure having the features of simple installation, easy and smooth operation, and various different unique operating modes to achieve the objectives and effects of a sport game with a variety of fun and recreation.

2. Description of the Related Art

In a triangular design of a skate car whose handlebar can be swayed to left and right sides to drive a car body as disclosed in U.S. Pat. Nos. 6,499,751B1, 6,517,093B2, 6,554,302B1, 6,827,358B2, and 6,976,687B2 and shown in FIGS. 1 and 2, the skate car comprises a front pipe 10, a freely rotating vertical pipe 11 pivotally coupled to the front pipe 10, a handlebar 12 disposed at the top of the vertical pipe 11, a front driving wheel 13 installed at the bottom of the vertical pipe 11 through a front fork 111, a pivotal ear 101 disposed at the bottom of the front pipe 10 for pivotally coupling a locking end 202 of an extended section 201 of left and right support rods 20 by a screw bolt 102 and a cushion element 103, a first through shaft 104 disposed on the pivotal ear 101 and at a backward position corresponding to the front pipe 10 for pivotally coupling a rotating member 14, a transversal second through shaft 141 disposed separately on both ends of the rotating member 14 for passing an shock-absorbing elastic member 15 and securing the shock-absorbing elastic member 15 into its position by a screw bolt 142 and the cushion element 143, and the left and right shock-absorbing elastic members 15 are transversally accommodated in the front shaft sleeve 203 of the left and right support rods 20, such that the front pipe 10 can swing to left and right by using the ground touching point of the front driving wheel 13 as a pivot point and the first through shaft 104 as a rotating point, and the shock-absorbing elastic member 15 is provided for absorbing the shocks and restoring the positions of the locking end 202, the extended section 201 and the shaft sleeve 203 of left and right support rod 20 exerted with the left and right swinging pressure. In addition, a load carrying wheel 21 is installed separately at the rear ends of the left and right support rods 20, and a carrier 22 is installed at the position of the load carrying wheel 21. After a user stands on the carrier 22 and holds the handlebar 12 with both hands, the user still can swing the handlebar 12 to the left and right sides to deviate the front driving wheel 13 to the left and right sides by swinging to roll forward in an S-shaped path, such that the whole skate car can achieve the effect of sliding forward for the fitness exercise purpose.

With reference to FIGS. 3 and 4, a folding structure disposed proximate to the front end of the left and right support rods 20 comprises: a pivotal ear 204 coupled to an end of shaft sleeve 203; a clamp 205 coupled to an end of a carrier 22 for pivotally coupling the pivotal ear 204 by a pivot 206; a sheath hole 2051 disposed at an end of the clamp 205 for accommodating a spring 207 and a pin 208, wherein the front end of the pin 208 is latched into a latch hole 2041 of the pivotal ear 204 by the resilience of the spring 207; a poke button 209 installed on a circumferential surface of the pin 208 and provided for separating the pin 208 from the latch hole 2041 by applying a force to move the poke button 209 backward, such that after the poke button 209 separates the pin 208 from the latch hole 2041, the support rod 20 installed at the carrier 22 and load carrying wheel 21 for using the pivot 206 as a rotating point for the folding operation, so as to reduce the overall volume of the skate car. When the pin 208 is latched into the latch hole 2041 by the resilience of the spring 207, the support rod 20 can be used for the operation of spreading open the skate car.

Undeniably, the aforementioned skate car can provide users the expected fitness exercise effect and achieve the effect of folding and reducing the volume of the skate car, but the conventional skate car still has the following drawbacks:

1. When the handlebar 12 is swayed sideway to the left and right, such that forces are exerted onto the extended section 201, the locking end 202 and the shaft sleeve 203 of left and right support rods 20 which are swayed accordingly, a damping force is provided by the shock-absorbing elastic member 15 contained in the shaft sleeve 203, so that when a user drives the car body to slide forward, an elastic force is applied to the shaft sleeve 203 only, and the shock absorption and force resumption are poor or insufficient, and thus resulting in a rigid, unnatural and unsmooth operation of the skate car.

2. Since a user can slide the whole car body forward by swinging the handlebar to left and right sides to swing the front driving wheel 13, but the force produced by both legs of the user cannot be applied alternately to the load carrying wheels 21 at the rear ends of the two support rods 20 to drive and move the car body, therefore it requires significantly more efforts to drive the skate car, and the movement is monotonous and even unsmooth and stiff.

3. Since the force produced by both legs of the user cannot be applied alternately to the two load carrying wheels 21, therefore a wheel may be lifted above the ground and give rise to an accident easily, when the car body is sliding and making a turn.

4. Since it is necessary to install a folding structure separately at a position proximate to the front end of the left and right support rods 20 before the skate car can be folded, the folding structure not just requires more components only, but also incurs a troublesome, complicated, laborious and cost-ineffective manufacturing process.

5. After the left and right support rods 20 are unfolded for use, the folding structure uses the pin 208 to the user's body weight solely, and thus there will be a risk of having deformations, separations, falling off or breaking of components of the skate car if forces are applied continuously to operate and drive the skate car to slide on various road surface while carrying the weight of the user.

### SUMMARY OF THE INVENTION

Therefore, it is a primary objective of the present invention to overcome the aforementioned shortcomings of the prior art by providing an improved skate car structure with the features of simple installation, easy and smooth operation, and various different unique operating modes to achieve the objectives and effects of a sport game with a variety of fun and recreation.

To achieve the aforementioned objective, the present invention provides an improved skate car structure, comprising: a control member installed at a frame that is provided for fixing a front pipe; an elastic restoring element installed in the control member, and coupled to the frame after a driving rod is passed through the elastic restoring element; a positioning ear disposed separately on both sides and provided for a pivoted bolt to pivotally install left and right support rods; a pivoted bolt installed separately on both sides of the frame proximate to the control member and provided for positioning the left and right support rods; a handlebar and a front driving wheel installed at upper and lower ends of the front pipe respectively; and a rear driving wheel module installed at a rear end of the left and right support rods and swung freely and restored automatically, such that after a user stands on the left and right support rods by both legs respectively, the user can twist his body or hip, apply forces by both legs, or swing the handlebar sideway by both hands to drive the car body to slide forward, so as to achieve the purpose and effect of a sport game with fun and a multiple of operating modes.

To make our examiner easier to understand the objects, characteristics and effects of the present invention, we use preferred embodiments and related drawings for the detailed description of the present invention as follows.

### BRIEF DESCRIPTION OF THE DRAWINGS

FIG. 1 is a schematic perspective view of a conventional skate car;

FIG. 2 is a schematic view of a connecting structure for connecting a front pipe to left and right support rods;

FIG. 3 is a schematic view of a folding assembly of the left and right support rods as depicted in FIG. 1;

FIG. 4 is a schematic view of operating the folding assembly as depicted in FIG. 3;

FIG. 5 is a schematic perspective view of spreading open a skate car in accordance with a first preferred embodiment of the present invention;

FIG. 6 is a schematic top view of a connecting structure of a frame, a control member and left and right support rods as depicted in FIG. 5;

FIG. 7 is a schematic side view of a connecting structure of a frame, a control member and left and right support rods as depicted in FIG. 5;

FIG. 8 is a schematic side view of a rear driving wheel as depicted in FIG. 5 installed at a rear end of a support rod;

FIG. 9 is a schematic view of swing a front pipe and a frame as depicted in FIG. 7 to the left side;

FIG. 10 is a schematic view of swing a front pipe and a frame as depicted in FIG. 7 to the right side;

FIG. 11 is a schematic top view of operating a rear driving wheel module as depicted in FIG. 7;

FIG. 12 is a schematic front view of FIG. 5;

FIG. 13 is a schematic front view of a folding operation as depicted in FIG. 12;

FIG. 14 is a schematic perspective view of an unfolded skate car in accordance with a second preferred embodiment of the present invention;

FIG. 15 is a schematic top view of a connecting structure of a frame, a control member and left and right support rods as depicted in FIG. 14;

FIG. 16 is a schematic side view of a connecting structure of a frame, a control member and left and right support rods as depicted in FIG. 14;

FIG. 17 is a schematic view of swinging a front pipe and a frame to the left side;

FIG. 18 is a schematic view of swinging a front pipe and a frame to the right side;

FIG. 19 is a schematic front view of FIG. 14; and

FIG. 20 is a schematic front view of a folding operation as depicted in FIG. 19.

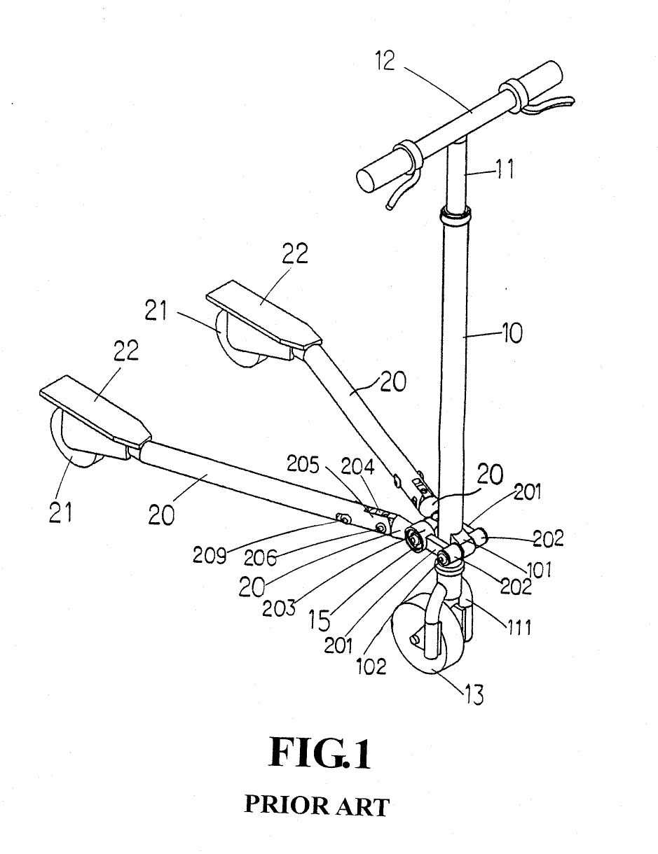

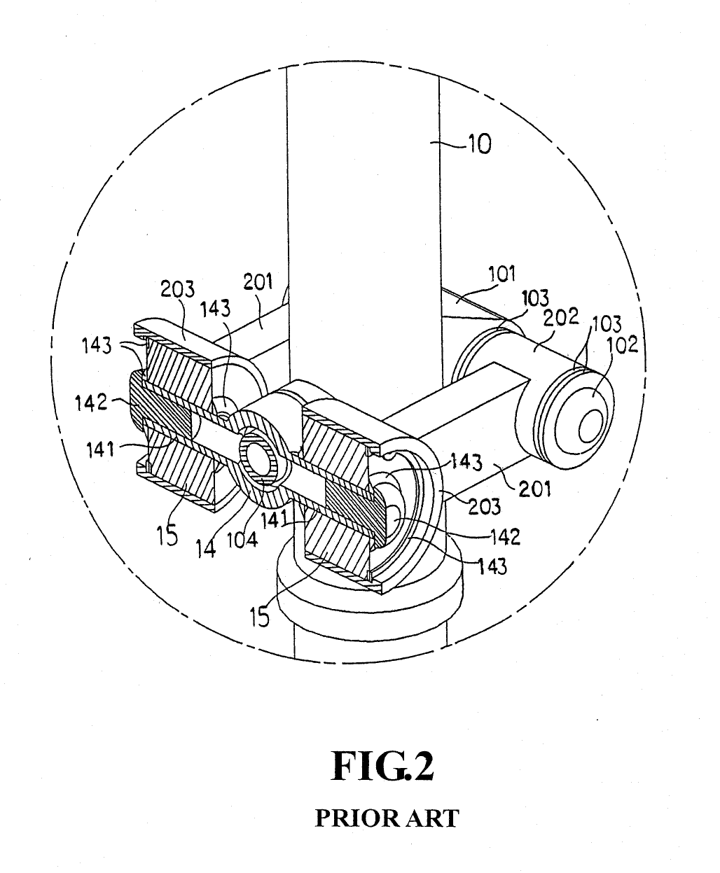

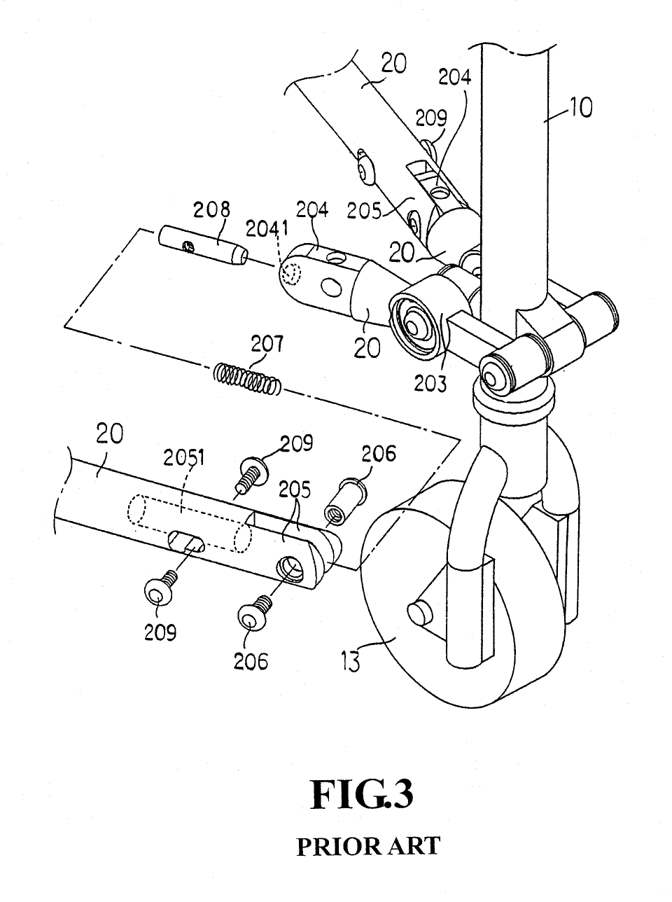

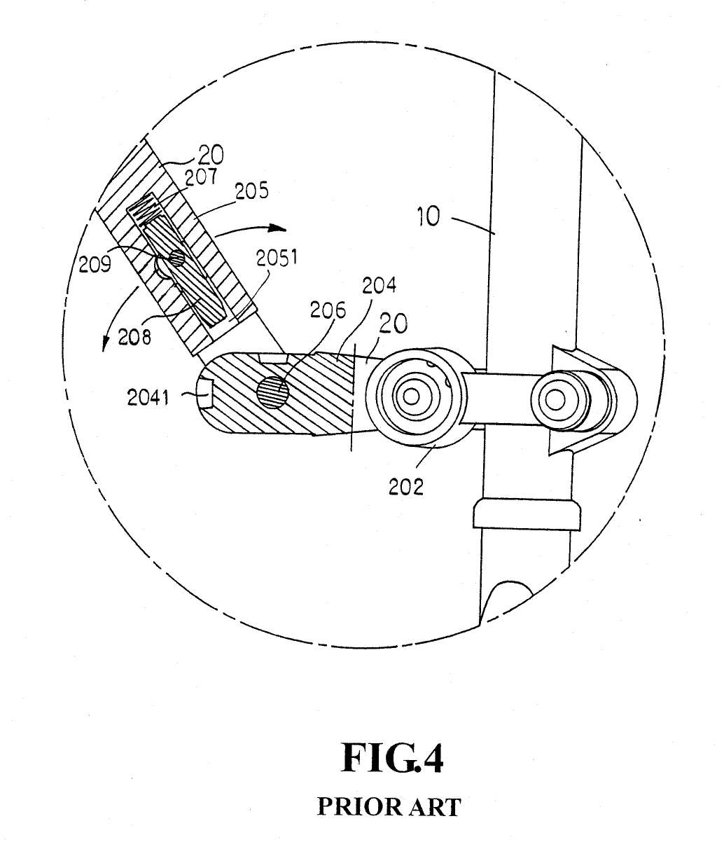

### DETAILED DESCRIPTION OF THE PREFERRED EMBODIMENTS

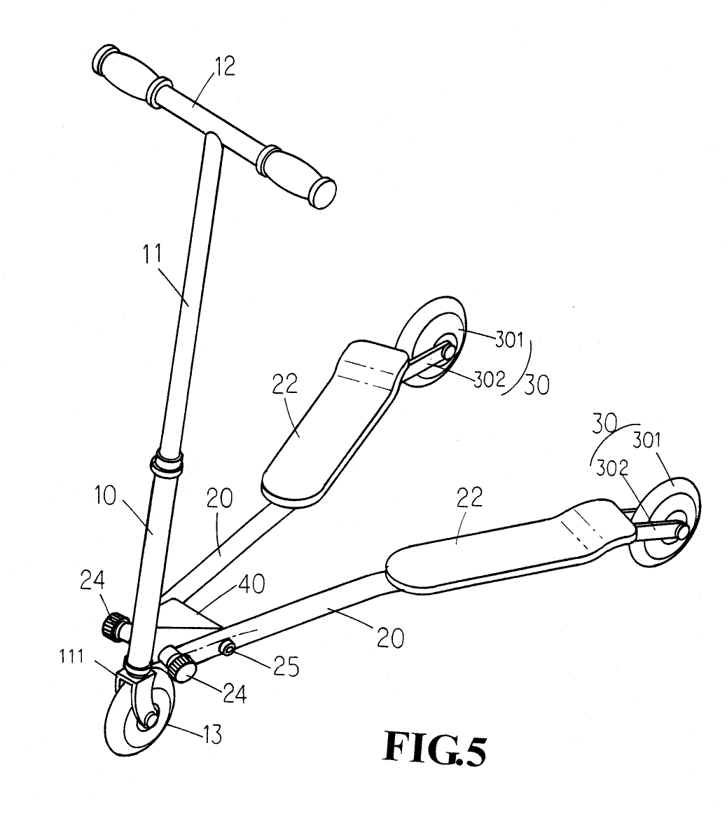

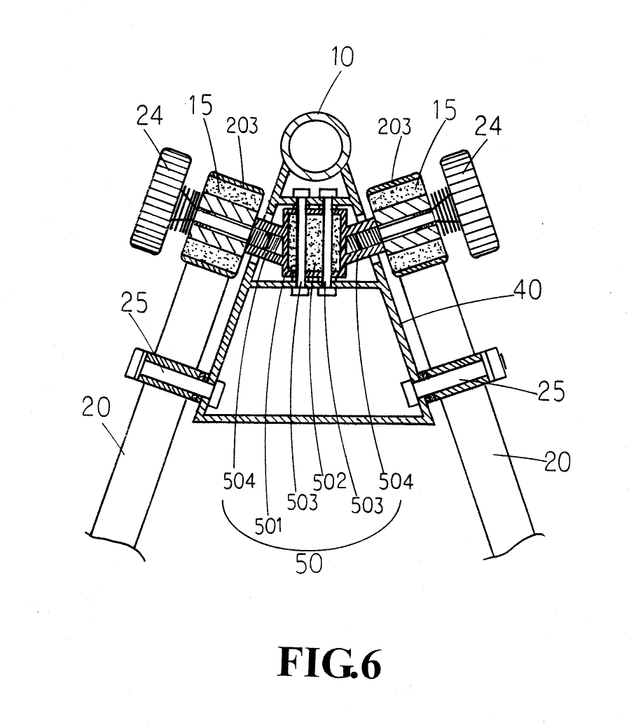

With reference to FIG. 5 for a first preferred embodiment of the present invention as well as FIGS. 6 to 8, the improved skate car structure of the present invention comprises a frame 40, having a front pipe 10 installed thereon, a freely rotating vertical pipe 11 pivotally coupled to the front pipe 10, a handlebar 12 installed at an upper end of the vertical pipe 11, a front driving wheel 13 installed at a lower end of the vertical pipe 11 through a front fork 111; a control member 50, installed in the frame 40, and including a containing body 501, an elastic restoring element 502 (which is made of rubber in this preferred embodiment) installed in the containing body 501, wherein the containing body 501 and the elastic restoring element 502 are non-rotably passed and coupled to the frame 40 by the driving rod 503 and a positioning ear 504 is disposed separately on both sides of the containing body 501, and after the driving rod 503 is connected to the frame 40, two or more driving rods 503 are installed to prevent the containing body 501 and the elastic restoring element 502 from being swung synchronously with the frame 40; left and right support rods 20, having a carrier 22 separately disposed thereon, a shaft sleeve 203 installed at a front end, and a shock-absorbing elastic member 15 (which is made of rubber in this preferred embodiment) contained in the shaft sleeve 203, and secured to a positioning ear 504 disposed separately on two corresponding side of the control member 50 by a pivoted bolt 24, and a pivoted bolt 25 disposed at a position proximate to the shaft sleeve 203 and pivotally coupled to the frame 40, such that when the pivoted bolt 24 is not secured to the positioning ear 504 of the control member 50, the frame 40 and the left and right support rods 20 can be swung with respect to each other by using the pivoted bolt 25 as a pivot point; left and right rear driving wheel module 30, having a rear driving wheel 301 each, such that a rear fork 302 and an obliquely rotating pivot 303 can be biasedly and pivotally installed at a rear end of the support rod 20, so as to support the skate car together with the front driving wheel 13.

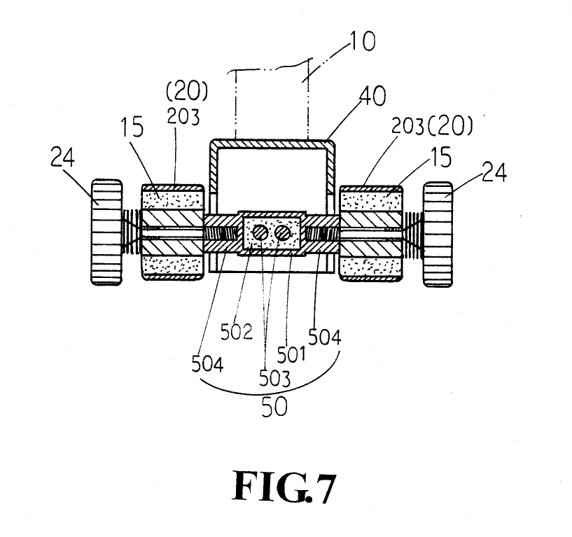

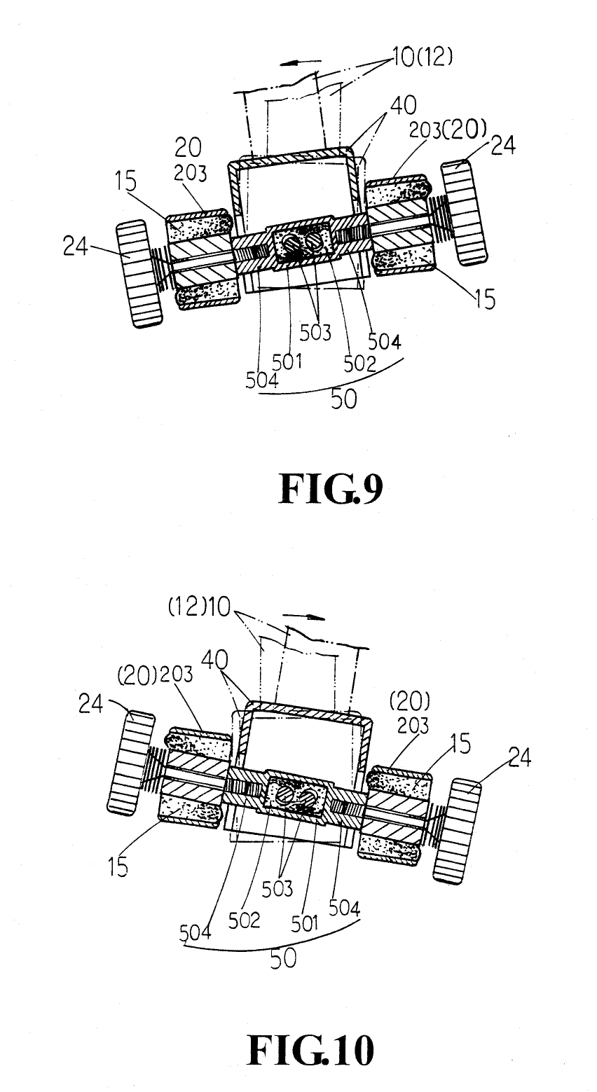

Since the left and right support rods 20 and the frame 40 are pivotally coupled by the pivoted bolt 25, therefore a user simply needs to install another pivoted bolt 24 at the left and right support rods 20 to secure the corresponding control member positioning ear 504, when the user wants to use the skate car, and the left and right support rods 20, the front pipe 10, and handlebar 12 can be unfolded quickly. The user can stand on the left and right carriers 22 by both legs and hold the handlebar 12 by both hands to operate the skate car. With reference to FIGS. 9 and 10, when the handlebar 12 is swung sideway to swing the vertical pipe 11, the front pipe 10, and the frame 40 together, the front driving wheel 13 disposed on the floor will produce a bias swing and roll forward in an S-shaped path to drive the car body forward, and the front end of the left and right support rods 20 is pivotally coupled to the frame 40 by a pivoted bolt 25, and secured to the control member 50 by another pivoted bolt 24, and the control member 50 is passed through by the driving rod 503 and coupled to the frame 40, such that the aforementioned components will be biasedly swung together. Since the shaft sleeve 203 passed with the pivoted bolt 24 includes the shock-absorbing elastic member 15, and the containing body 501 of the control member 50 passed with the driving rod 503 also includes the elastic restoring element 502, therefore when the left and right support rods 20 are biasedly swung, the shock-absorbing elastic member 15 installed in the shaft sleeve 203 provides a shock absorption and a restoring force (as shown in FIGS. 7, 9 and 10). Particularly, the driving rod 503 passed through the frame 40 will exert a pressure onto the corresponding elastic restoring element 502 as it biasedly swings together with the frame 40 (as shown in FIGS. 7, 9 and 10), such that the compressed elastic restoring element 502 will exert an elastic force to the containing body 501 and the positioning ear 504 of the control member 50 and further provides a shock absorption and a restoring force to the secured pivoted bolt 24 and the passed shaft sleeve 203, and the biasedly swung left and right support rods 20 still can obtain the shock absorption and restoring force. In other words, the handlebar 12 is turned sideway to exert a pressure to biasedly swing the left and right support rods 20, such that the left and right support rods 20 can obtain the shock absorption and restoring force from the shock-absorbing elastic member 15 installed in the shaft sleeve 203, while obtaining the shock absorption and restoring force from the elastic restoring element of the control member 50. With the double effects of shock absorption and restoring force, the operation of the skate car including the operations of turning the handlebar 12 sideway and restoring the left and right support rods 20 to their original position an be smooth, natural and effort-saving.

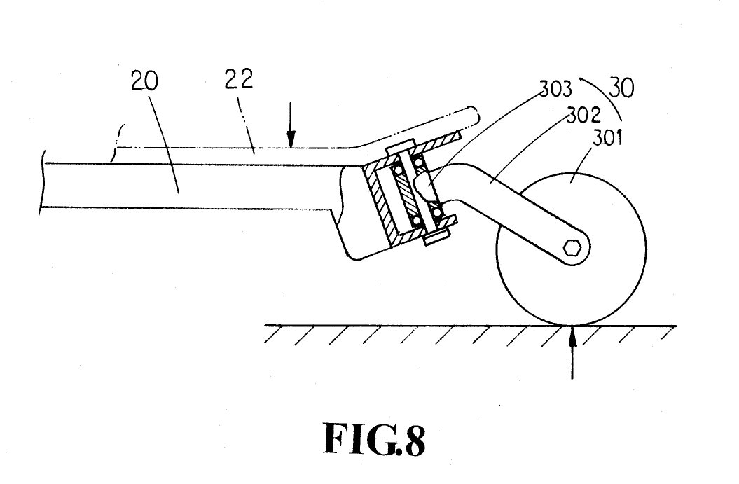

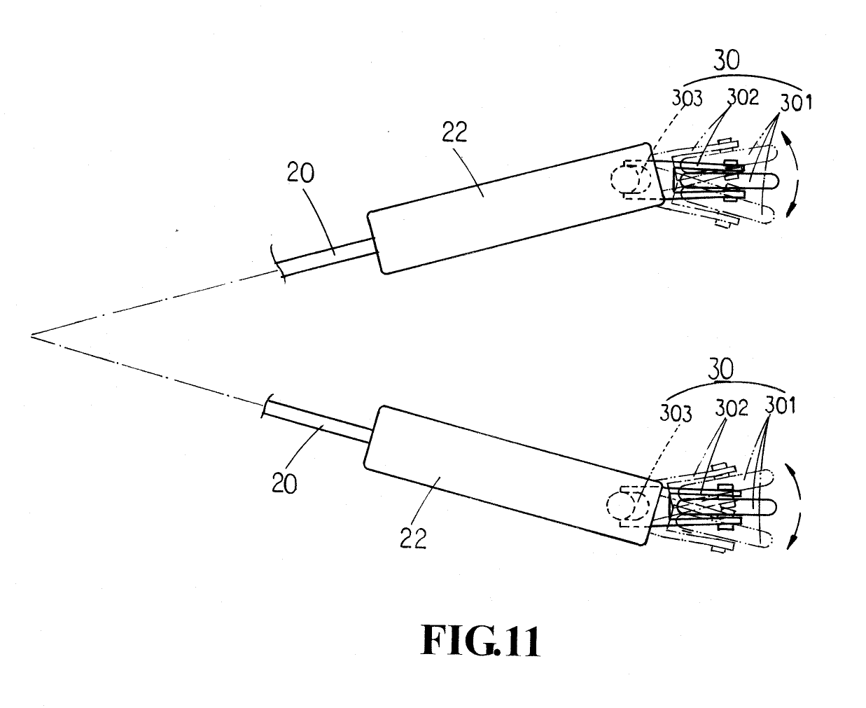

With reference to FIG. 8, a rear driving wheel module 30 is separately and biasedly installed at the rear ends of the left and right support rods 20, so that when a user standing on the carriers 22 applies a force downward by both legs, the biasedly rotating pivot 303 will guide the rear driving wheel 301 automatically to a correct movement through the rear fork 302, such that the skate car can be operated by turning the handlebar 12, or the user can also stand on the left and right carriers 22 by both legs as shown in FIG. 11, and then apply forces alternately by both legs or twist the body or hip to operate the skate car. In other words, the rear driving wheel module 30 can be biasedly and pivotally coupled to the rear ends of the left and right support rods 20, such that when the user applies forces by both legs or twists his body or hip to apply forces to the left and right carriers 22, the biasedly swung rear driving wheel 301 will be guided automatically during the swing and restore its original position. By the continuous forces, the car body can be rolled along an S-shaped path to slide forward.

Since the shock-absorbing elastic member 15 and the elastic restoring element 502 are operated together to roll the front driving wheel 13, to biasedly swing the handlebar 12, and restore the position of the left and right support rods 20, a smooth, natural and effort-saving effect can be achieved, and the biasedly and pivotally installed rear driving wheel module 30 can be guided automatically, therefore the user can apply forces by both legs or twist his body or hip to operate the left and right carriers 22 in order to roll the rear driving wheel 301 forward smoothly to drive the car body. During the operation of the skate car of the present invention, the user can swing the handlebar 12 by both hands, apply forces alternately by both legs, or twist the body or hip to apply forces to the left and right carriers 22, and such operation not only provides a smooth, natural and effort-saving effect to the operation of the skate car, but also provides a unique sport game with fun and recreation and a multiple of operating modes.

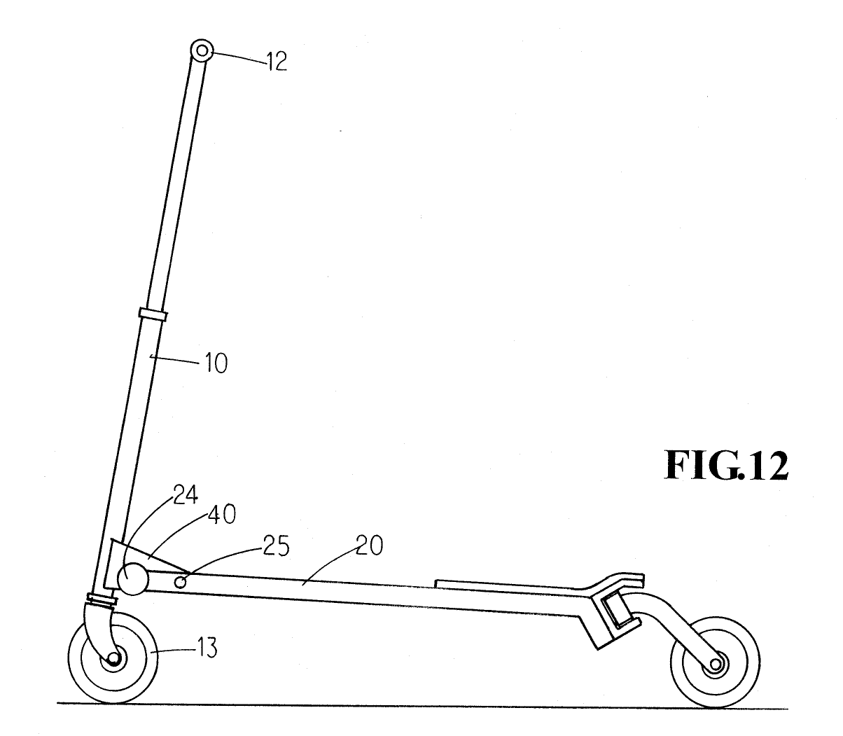

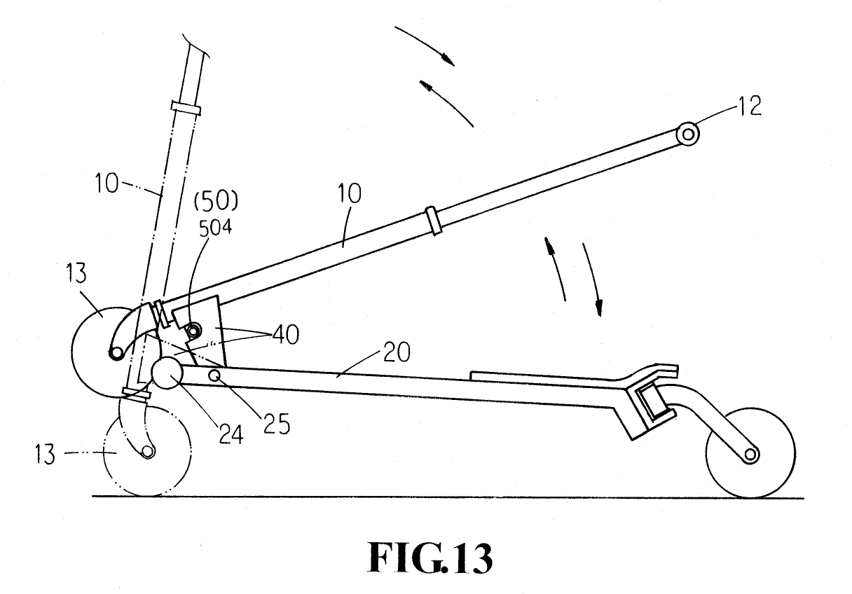

With reference to FIGS. 12 and 13, the left and right support rods 20 are pivotally coupled to the frame 40 by the pivoted bolt 25, and when another pivoted bolt 24 is provided for securing the left and right support rods 20 to the positioning ear 504 of the control member 50 (as shown in FIG. 6), the front pipe 10 and the handlebar 12 can be unfolded, so that the user can loosen the pivoted bolt 24 to detach the control member 50, and use the pivoted bolt 25 as a pivot point to fold the front pipe 10 and the handlebar 12 downward to stack the left and right carriers 20 together in order to reduce the storage volume. Obviously, the skate car of the present invention can be unfolded or folded easily, conveniently and quickly.

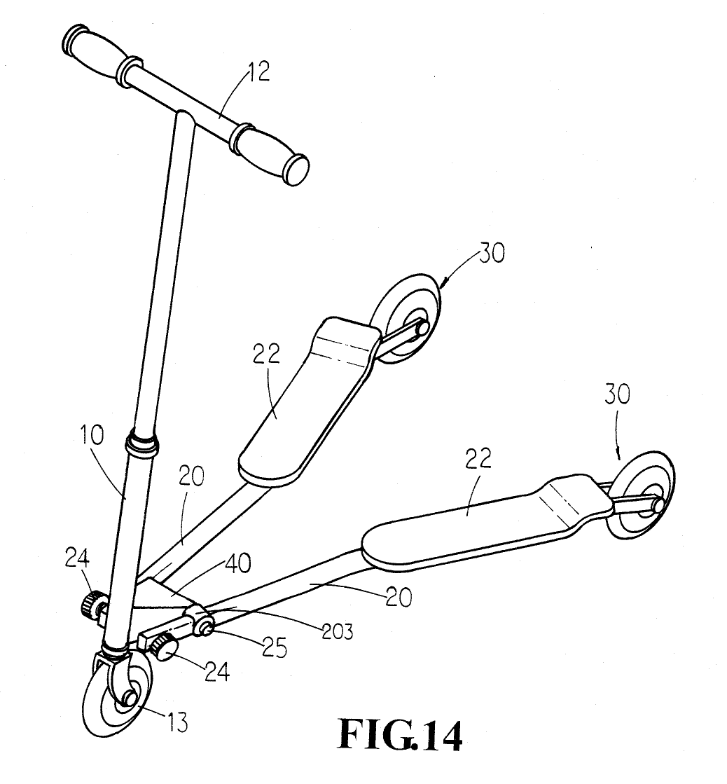

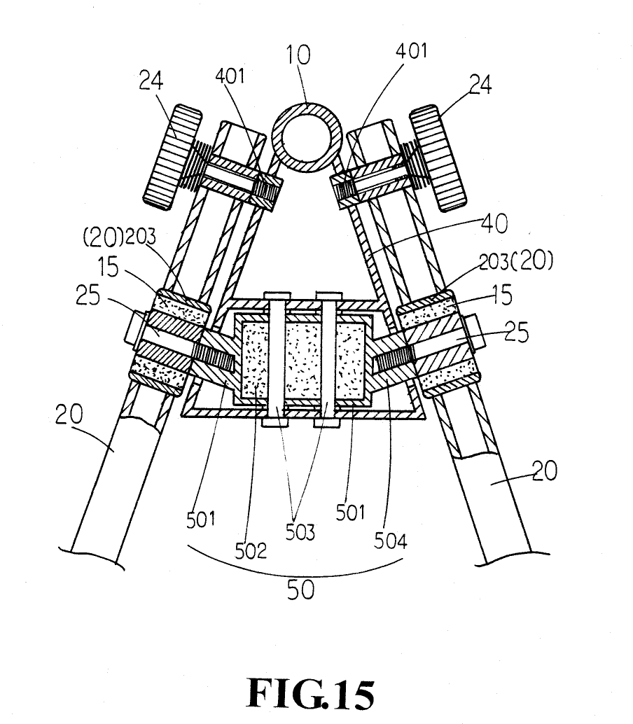

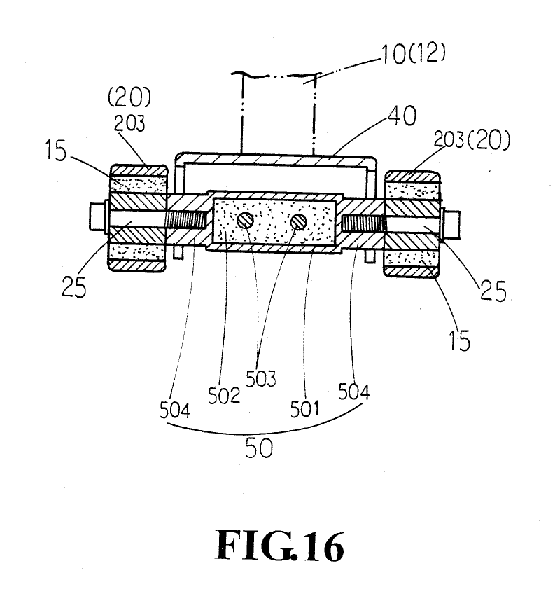

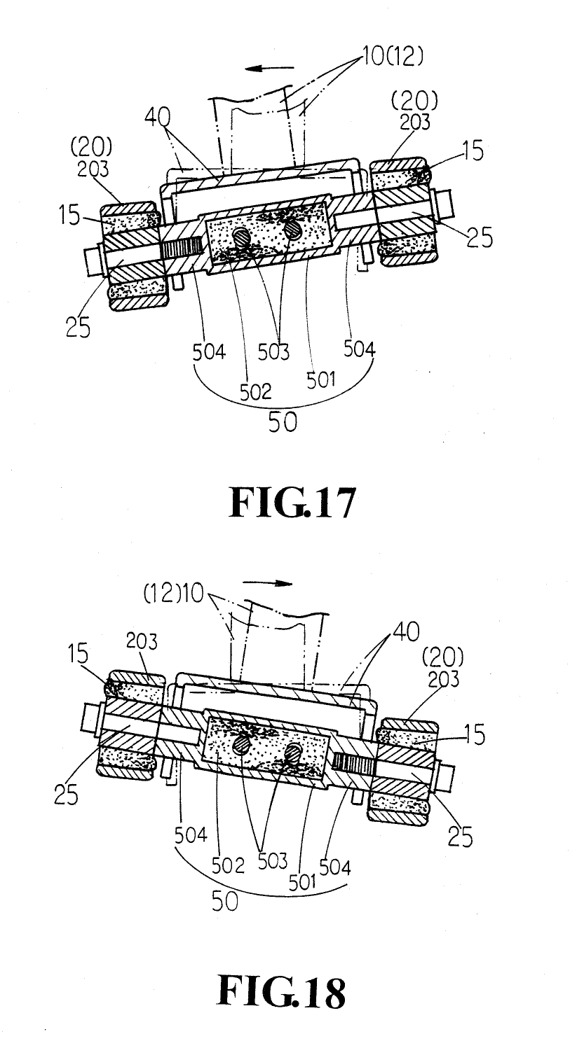

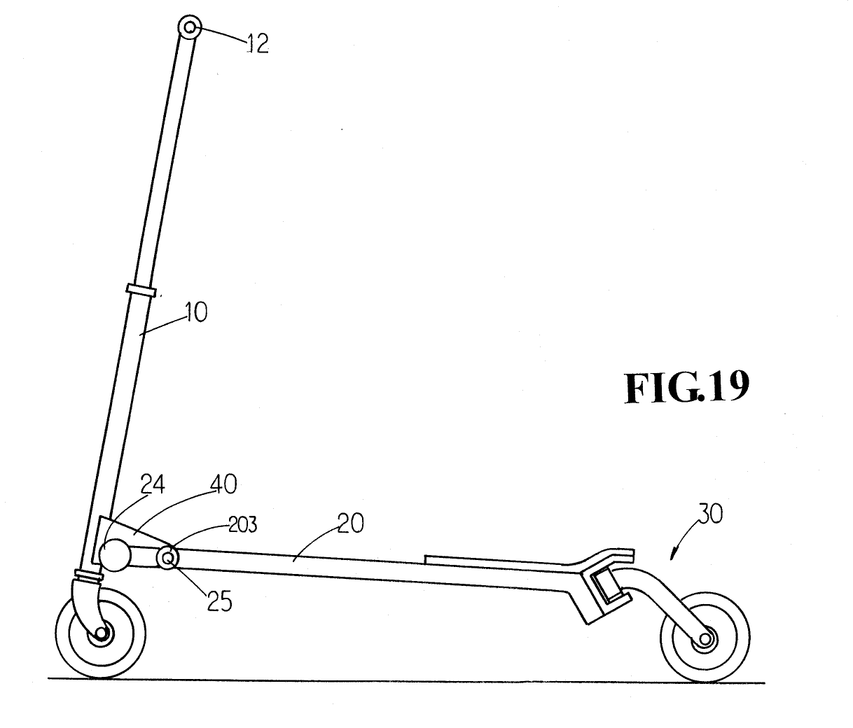

With reference to FIG. 14 for a second preferred embodiment of the present invention together with FIGS. 15 and 16, the principle of the operation is similar to that of the first preferred embodiment, wherein the control member 50 is shifted towards the rear end of the frame 40, and the shaft sleeve 203 having the installed shock-absorbing elastic member 15 is installed at a position corresponding to the left and right support rods 20 and pivotally coupled by a pivoted bolt 25, and a pivoted bolt 24 is installed at a front end of the frame 40 and at a position corresponding to the left and right support rods 20. In other words, the control member 50 also includes a containing body 501 for containing the elastic restoring element 502, and the containing body 501 is also passed through by the driving rod 503 and coupled to the frame 40, and the positioning ear 504 disposed separately on both sides is provided for pivotally positioning the pivoted bolt 25 that is passed through the shaft sleeve 203. With reference to FIGS. 17 and 18, when a user stands on the carriers 22 by both legs and swings the handlebar 12 sideway by both hands, the shock-absorbing elastic member 15 installed in the shaft sleeve 203 and the elastic restoring element 502 installed in the control member 50 will provide a shock absorption and a restoring force to the biasedly swung handlebar 12 and left and right support rods 20, so as to provide a smooth, natural and effort-saving operation to the skate car.

With reference to FIG. 19, the rear ends of the left and right support rods 20 are biasedly installed to have the automatic guiding effect and restoring the position of the rear driving wheel module 30, so that the user can swing the handlebar 12 to drive the skate car, or apply forces alternately by both legs, or twist his body or hip to apply forces to the left and right support rods 20 to drive the skate car, or use the aforementioned operating methods alternately to drive the skate car, so as to achieve the effects of providing a smooth, natural and effort-saving operation of the skate car, and providing a sport game with fun and recreation and a multiple of operating modes.

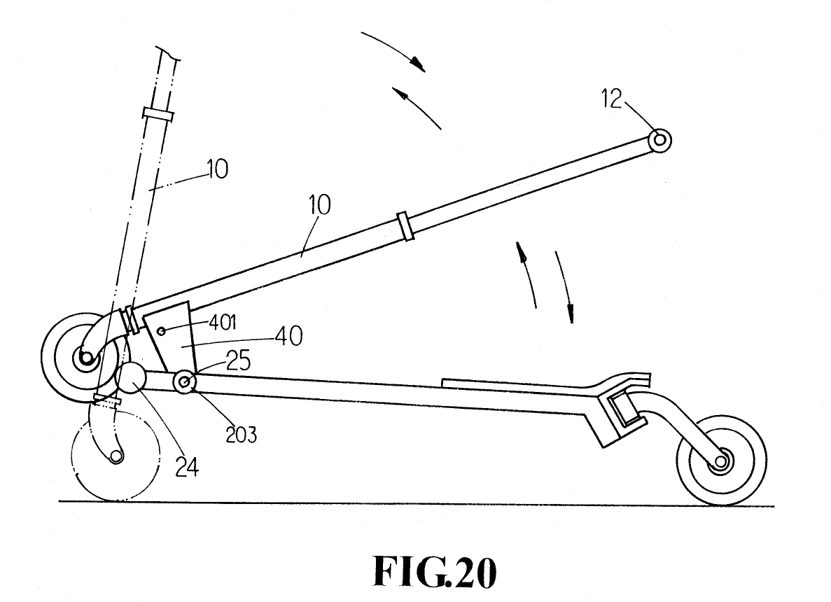

With reference to FIG. 20, the pivoted bolt 25 passed through the shaft sleeve 203 is pivotally installed at the positioning ear 504 of the control member 50, such that when the skate car is operated, the pivoted bolt 25 can be used as a pivot point to lift the front pipe 10 upward and secure another pivoted bolt 24 installed at the left and right support rods 20 to a pre-formed screw hole 401 of the frame 40 (as shown in FIGS. 15 and 20). On the other hand, if the pivoted bolt 24 is loosened to separate from the frame 40, the handlebar 12 and the front pipe 10 can be turned downward by using the pivoted bolt 25 as the pivot point to achieve the expected folding effect to reduce the storage volume.

In the operations of spreading open and folding the skate car in accordance with the first preferred embodiment and the second preferred embodiment, the pivoted bolt 25 installed at the rear end of the frame 40 or the pivoted bolt 25 of the control member 50 installed at the rear end of the frame 40 is used as a pivot point, and the pivoted bolt 25 used as a pivot point can be pivotally installed at the front end of the frame 40 or at the position of the control member 50 at the front end of the frame 40 instead, so as to achieve the purposes and effects of unfolding and folding the skate car easily and conveniently.

In other words, the present invention at least has the following advantages:
1. The invention has the features of a simple manufacture, a simple and easy operation, and a convenient and safe application.
2. The skate car comes with a smooth, natural and effort-saving operation.
3. The skate car provides a unique sport game with fun and recreation and a multiple of operating modes.
4. The skate car can be unfolded or folded easily, conveniently and quickly.

What is claimed is:

1. An improved skate car structure, comprising a frame, a front pipe installed at the frame, a vertical pipe pivotally installed at the front pipe, a handlebar and a front driving wheel installed at upper and lower ends of the vertical pipe respectively, left and right support rods pivotally coupled to the frame, and a carrier and a rear driving wheel module installed at the left and right support rods respectively; characterized in that a control member is installed at frame, and the control member includes a containing body, an elastic restoring element installed at the containing body, and the containing body and the elastic restoring element are non-rotably passed and coupled to the frame by a driving rod, and a positioning ear is disposed separately on both sides of the containing body and includes a pivoted bolt for pivotally positioning the left and right support rods.

2. The improved skate car structure of claim 1, wherein the elastic restoring element installed at the control member is made of rubber.

3. The improved skate car structure of claim 1, wherein the driving rod comes with a quantity of two or more.

4. The improved skate car structure of claim 1, wherein the control member includes a shaft sleeve installed separately at the left and right support rods corresponding to both sides of the positioning ear, a shock-absorbing elastic member installed in the shaft sleeve and pivotally coupled to the positioning ear of the control member by the pivoted bolt.

5. The improved skate car structure of claim 4, wherein the shock-absorbing elastic member installed in the shaft sleeve is made of rubber.

6. The improved skate car structure of claim 1, further comprising a pivoted bolt disposed at the shaft sleeve proximate to the left and right support rods and pivotally coupled to the frame.

7. The improved skate car structure of claim 1, wherein the rear driving wheel module includes a rear driving wheel, and the rear driving wheel is biasedly and pivotally coupled to a rear end of the support rod through a rear fork and an obliquely rotating pivot.
